(19) United States
(12) Patent Application Publication
(10) Pub. No.: US 2013/0208843 A1
(43) Pub. Date: Aug. 15, 2013

(54) NEUTRON ACTIVATION ANALYSIS USING A STANDARDIZED SAMPLE CONTAINER FOR DETERMINING THE NEUTRON FLUX

(71) Applicants: Eric Mauerhofer, Juelich (DE); John Kettler, Aachen (DE)

(72) Inventors: Eric Mauerhofer, Juelich (DE); John Kettler, Aachen (DE)

(21) Appl. No.: 13/810,035

(22) PCT Filed: Jul. 19, 2011
(86) PCT No.: PCT/DE11/01476

§ 371 Date: Feb. 14, 2013

(30) Foreign Application Priority Data
Jul. 22, 2010 (DE) 10 2010 031 844.2

(51) Int. Cl. G01N 23/222

(52) U.S. Cl. CPC G01N 23/222
USPC 376/159

(57) ABSTRACT

A method for the non-destructive elemental analysis of large-volume samples using neutron radiation and a device for carrying out the method. In the method, the sample is irradiated with fast neutrons in a pulsed manner and the gamma radiation emitted by the sample is measured. The quantity of an element contained in the sample is evaluated after the background signal is subtracted from the area of the photopeak caused by the element in a plot of count rate versus energy. The gamma radiation emitted by a subregion of the sample, the composition of which is known, is evaluated in order to determine the neutron flux at the location of the sample. A metallic enclosure of the sample, such as a standardized waste container, can be selected as such a subregion, for example. A novel evaluation method based on multiparameter analysis can quantify, on the basis thereof, the presence of individual elements more quickly and more accurately than is possible according to the previous prior art. The device is characterized by a sample chamber, which is surrounded by a neutron-reflecting material, in particular graphite.

The invention relates to a method for the non-destructive elemental analysis of large-volume samples using neutron radiation and to a device for carrying out the method.

### STATE OF THE ART

In the handling and, especially, the storage of hazardous materials, it is important to know exactly what the materials are. Particularly problematic in this context are mixed wastes, such as drums of waste containing a collection of objects contaminated with various hazardous materials. It is dangerous to come in contact with the waste without knowing what hazardous materials are present. In order to obtain this knowledge, however, one must come in contact with the waste. Due to the necessary safety measures, it is very complex and expensive, for example, to remove a drilling core for analysis from a drum in which radioactive waste is encased in concrete.

Neutron activation analysis offers a way out. This involves irradiating the sample with neutrons. The atomic nuclei in the sample are thereby excited to emit gamma radiation, which presents a characteristic signature for every element. By evaluating the gamma radiation emitted by the sample, it is therefore possible to non-destructively investigate which elements are present in the sample.

Especially with regard for the examination of large-volume objects, a method is known from WO 01/07888 A2 for the determination of metals in non-radioactive, large-volume samples that are classified as particularly hazardous according to the American “Resource Conservation and Recovery Act” (RCRA). This involves exposing the sample to pulsed neutron radiation. In the spectrum of gamma radiation emitted by the sample, the prompt and delayed gamma radiation of the atomic nuclei in the sample induced by the neutron pulse is evaluated. This is used to determine the elements present in the sample.

Disadvantageously, the quantification of elements in the sample requires time-consuming and computationally intensive Monte Carlo simulations, thereby making the method unsuitable for serial measures of several samples at a high throughput rate.

### OBJECT AND SOLUTION

Therefore, the object of the invention is to provide a method for the non-destructive elemental analysis of large-volume samples that can be carried out more quickly and is therefore suitable for routine serial measurements at a high throughput rate.

This object is achieved according to the invention by a method according to the main claim and by a device according to an alternate independent claim. Further advantageous embodiments will become apparent from the dependent claims related thereto.

### SUBJECT MATTER OF THE INVENTION

Within the scope of the invention, a method was developed for the non-destructive elemental analysis of large-volume samples. According thereto, the sample is irradiated with fast neutrons in a pulsed manner and the gamma radiation emitted by the sample is measured. The quantity of an element contained in the sample is evaluated after the background signal is subtracted from the area of the photopeak caused by the element in a plot of count rate versus energy.

According to the invention, the gamma radiation emitted by a subregion of the sample, the composition of which is known, is evaluated in order to determine the neutron flux at the location of the sample. A metallic enclosure of the sample, for example, can be selected as such a subregion. Chemical and radioactive wastes in particular are often packed in standard steel drums, which can be preferably used for measuring the neutron flux. The term “neutron flux” refers to both slow neutrons and fast neutrons.

The method according to the invention and the device are also suitable, for example, for the elemental analysis and quality control of samples or materials from the recycling industry field. It is thereby possible, for example, to evaluate waste from the field of the glass, plastic, or metal industries, the electrical/electronic waste industry, the alternative fuel industry, as well as mixed waste generated in the construction industry, the trade industry, the automotive industry, the excavation industry, and wastes having metals/metal compounds and transition metals/transition metal compounds (for example, antimony, beryllium, cobalt, fluor-spar, gallium, germanium, indium, magnesium, niobium, metals from the platinum group, tantalum, or tungsten), industrial mineral wastes, or wastes that contain rare earth metals.

The quantity of an element contained in the sample is evaluated after the background signal is subtracted from the area of the photopeak caused by the element in a plot of count rate versus energy. This net photopeak area P(E_{γ}) of a peak centered around the gamma energy E_{γ} is given by:

$$P ( {E}_{γ} ) = \frac{m}{M} \cdot A \cdot σ ( {E}_{γ} ) \cdot ɛ ( {E}_{γ} ) \cdot Φ \cdot {f}_{t} .$$

Therein, M is the known molar mass of the element. A is the Avogadro constant, and σ(Eγ) is the nuclear cross section of the element, which is also known, for the photon production. fₜ is a time factor that is dependent on whether the gamma radiation was excited by slow or fast neutrons and whether the gamma radiation is prompt or delayed. Therefore, fₜ is dependent not only on the type of radiation, but also on the type of measurement that is carried out and, in the case of irradiation using delayed neutrons, said time factor is also dependent on the half-life of the nuclides that are produced. Therefore, fₜ is always known. In order to be able to determine the total the mass m of the sought element present in the sample, the only unknowns left to determine are the photopeak efficiency ε(E_{γ}) and the neutron flux φ at the location of the sample.

It was found that the evaluation of the gamma radiation from the region of the sample having a known composition (calibration region) reveals the neutron flux φ at the location of the sample using experimentation that is simple, reproducible, and precise. Since the composition of the calibration region is known, the material-specific gamma energies that are emitted from this region are also known. Therefore, the gamma radiation from the calibration region can be distinguished from the gamma radiation from the rest of the sample. Therefore, P(E_{γ}) for the radiation from the calibration region is known and can be inserted into the equation above. In addition to the quantities M, A, σ(E_{γ}), and fₜ, the mass m of the calibration region is known, and so only the photopeak efficiency ε(E_{γ}) needs to be determined in order to solve the equation for the neutron flux φ at the location of the sample. The photopeak efficiency ε(E_{γ}) of the calibration region (steel drum) is also dependent only on the composition and geometry of the calibration region, which are known, and is therefore also accessible. This is a fixed quantity, in particular when the aim is to examine a series of samples, each of which is enclosed in a standard steel drum. The steel drum can then function as a calibration region in each case.

Therefore, all the quantities that are required in order to determine φ are known. This flux is homogeneous in the entire sample when irradiation is carried out using slow neutrons. For fast neutrons, the flux in the interior of the sample is diminished by shielding effects. These shielding effects are known, however, and can be adjusted for in order to determine a mean fast-neutron flux. This mean fast-neutron flux can be used to quantify the occurrence of the element being sought in the sample.

According to the prior art, the only way to estimate the neutron flux at the location of the sample was via Monte Carlo simulations. This is an iterative and highly computationally intensive procedure. For a large-volume sample, such as a waste drum, after the actual measurement was performed, computing times of up to one day were required on standard PC hardware merely to estimate the neutron flux. According to the invention, the neutron flux is not estimated, but rather is actually measured. This avoids the high computational complexity while also increasing the accuracy of the final result.

Strictly speaking, the neutron flux φ measured in this manner is not the true neutron flux, but rather an effective neutron flux in the sense that this is diminished for locations from which only a small portion of the emitted gamma radiation reaches the detector. If the objective is to examine a steel drum filled with concrete, for example, and a lateral surface of the drum faces the detector, gamma radiation that is emitted from the lateral surface of the drum facing away from the detector is attenuated by the concrete filling. However, it is precisely this effective neutron flux that is decisive for the quantification of elements from the net photopeak area P(E_{γ}) because the same shielding effects also occur in the determination of P(E_{γ}).

Therefore, the only remaining unknown is the photopeak efficiency ε(E_{γ}) of the sought element in the sample. This depends on the geometric distribution of the element in the sample and on the shielding experienced by the gamma radiation emitted by the element by way of the large-volume sample.

In a particularly advantageous embodiment of the invention, in order to determine this distribution, the sample is rotated about an axis and the gamma radiation is measured as a function of the rotational angle. Gamma radiation that does not change as a function of the rotational angle originates from elements that are distributed in the sample in a more or less homogeneous manner. Gamma radiation that shows a clear angle-dependence originates from localized inclusions in the sample. The sample can also be rotated about two axes in succession that are linearly independent of one another in order to also detect inclusions that are concentrated exclusively along the first axis and therefore exhibit no rotational-angle dependence upon rotation about said axis.

Typically, the sample is rotated between eight angular positions that are each separated by 45°. Measurements are typically carried out for 20 minutes in each angular position.

Advantageously, the radial distribution of an element in the sample relative to the rotational axis is evaluated on the basis of the dependence of the gamma radiation on the rotational angle. For example, an approach using free parameters can be formulated for the distribution, and the dependence on the rotational angle resulting from this distribution can be fitted to the dependence on the rotational angle determined via experimentation by changing the parameters.

In a particularly advantageous embodiment of the invention, the sample is approximated for the determination of the photopeak efficiency of the element as a shielded point source comprising the element. The photopeak efficiency ε(E_{γ}) can then be calculated via numerical integration using the equation:

$$ɛ ( {E}_{γ} ) = \frac{1}{{\sum }_{i = 1}^{N} {ω}_{i}} \cdot {{\sum }_{i = 1}}^{𝒩} ( \begin{matrix}exp ( - {( \frac{μ}{ρ} )}_{s} \cdot {ρ}_{s} \cdot {d}_{s , i} ) \cdot \\ exp ( - {( \frac{μ}{ρ} )}_{m} \cdot {ρ}_{m} \cdot {d}_{m , i} ) \cdot \cdot {ɛ}_{0} ( {E}_{γ} ) \cdot {( \frac{{d}_{0}}{{d}_{i}} )}^{2} \cdot {ω}_{i}\end{matrix} )$$

This equation applies for the calculation of photopeak efficiency ε(E_{γ}) in every case in which a sample surrounded by a calibration region (steel drum) is activated using slow and/or fast neutrons. In said equation. N is the number of points i into which the volume of the sample was discretized. The greater N is, the more precise the result is, but more time is required to perform the calculation. d_{m,i} and d_{s,i} are the distances that the gamma radiation originating from the location i must travel in the matrix of the sample or in the calibration region (the steel drum enclosing the sample) to the detector. ρₘ and ρₛ are the densities of the matrix of the sample (contents of the steel drum) or of the calibration region (steel drum). (μ/ρ)ₘ and (μ/ρ)ₛ are the mass attenuation coefficients of the matrix of the sample or the calibration region (steel drum), ρₘ is the mean apparent density of the sample without enclosure. This can be obtained as a quotient of the total mass of the sample minus the known mass of the steel drum and the internal volume of the steel drum. In all the examples provided in this description, it assumed that, in the interest of optimal utilization of space, the steel drum is always completely filled with the matrix (such as a concrete filling). If this appears doubtful in a specific situation, the state of filling of the drum can be examined in advance in a non-destructive manner using methods of digital radiography.

ε₀(E_{γ}) is the photopeak efficiency of a point source in the center of the sample located at the distance d₀ from the detector. dᵢ is the distance of the field point under consideration from the detector. The photopeak efficiency, ε₀(E_{γ}), for a point source at a distance d₀ from the HPGe detector was determined up to 10 MeV via normalization of a photopeak efficiency curve. To this end, an empty steel drum was irradiated with neutrons having various energies and the photopeak area P(E_{γ}) depending on the gamma energy E_{γ} was measured. Qualitatively, this curve has a shape similar to the dependence of the photopeak area P(E_{γ}) on the gamma energy E_{γ} for a punctiform test radiation emitter. The latter dependence was measured using test radiation emitters for gamma energies up to 1.4 MeV. The required normalization is obtained by comparing the curve shapes.

ωᵢ is the weighting factor of the field point for the activity distribution. It depends substantially on the neutron energy; when slow neutrons are used, the sample can be illuminated via multiple reflections in such a way that said sample is homogeneously irradiated. The activity distribution is then homogeneous as well, and therefore all weighting factors are equal to 1. For fast neutrons, however, the weighting factor depends on the macroscopic nuclear cross section and the mean range of the neutrons in the irradiated material:

ωᵢ=exp(−Σ_{S}·I_{s,f})·exp(−Σ_{M}·I_{M,i})

Therein, Σ_{S} and Σ_{M} are the macroscopic nuclear cross sections for the absorption of fast neutrons in the calibration region (steel drum) or in the matrix of the sample. The quantities I_{S,i} and I_{M,i}, are the mean distances traveled by the fast neutrons (having an energy of 14 MeV, for example) in the calibration region (steel drum) and in the matrix of the sample, respectively, until said neutrons are finally absorbed at the location i and excite the sample to emit gamma radiation. The value Σ_{S} is determined from the known material composition of the calibration region, which is primarily iron in the case of a steel drum. The value Σ_{M} is determined from the evaluation of previously conducted activation trials using slow neutrons and from the mean density of the measurement object. It therefore makes sense to first evaluate the data that are related to activation by slow neutrons and to then evaluate the data that relate to activation by fast neutrons.

In a further advantageous embodiment of the invention, a previously determined radial distribution of the element in the sample relative to the rotational axis is used to approximate the sample. If it is known via the measurement, for example, that the element is homogeneously distributed in the sample, the aforementioned approximation can be further simplified for the photopeak efficiency ε(E_{γ}) thereof. The total mass m thereof in the sample can then be quantified using the simplified formula:

$$m = \frac{M}{N \cdot σ ( {E}_{r} ) \cdot Φ} \cdot \frac{P ( {E}_{γ} )}{{ɛ}_{0} ( {E}_{γ} ) \cdot {F}_{0}} \cdot \frac{{( \frac{μ}{ρ} )}_{m} \cdot {ρ}_{m} \cdot V}{1 - exp ( {( \frac{μ}{ρ} )}_{m} \cdot {ρ}_{m} \cdot ( R - {d}_{s} ) )} \cdot \cdot exp ( {( \frac{μ}{ρ} )}_{s} \cdot {ρ}_{s} \cdot {d}_{s} )$$

Therein, V is the volume and R is the radius of the sample (drum with contents). F₀ is the cross-sectional area in the center of the sample that faces the detector. dₛ is the thickness of the calibration region (wall thickness of the steel drum). A homogeneous distribution of the sought element in the sample is given, for example, when the sample is rotated and the photopeak area P(E_{γ}) does not depend on the angle of rotation θ.

In a further particularly advantageous embodiment of the invention, the area of the photopeak is calculated using an assumption for a gamma-shielding structure contained in the sample. The comparison of this area with the area obtained from measurement results is evaluated as a measure of the validity of the assumption. In particular, the validity of the assumption can be evaluated using a chi-squared test of the deviation between the area of the photopeak that was calculated and the area of the photopeak obtained from measurement results.

For example, the first assumption can be that the sample contains no shielding structure. The area of the photopeak calculated on the basis of this assumption is compared to the area obtained from measurement results, in particular using a chi-squared test. If there is no significant deviation, it can be assumed that there are no shielding structures. If a significant deviation does result, however, the assumption is incorrect and it must be assumed that shielding structures are present.

If the sought element in the sample is homogeneously distributed, the following test statistic, for example, can be applied for the chi-squared test:

$${χ}^{2} = {\sum }_{i , j} \frac{{( \frac{P ( {E}_{γ} , i )}{P ( {E}_{γ} , j )} - {q}_{i , j} )}^{2}}{{q}_{i , j}}$$

for i≠j with

$${q}_{i , j} = \frac{σ ( {E}_{γ} , i ) \cdot {ɛ}_{0} ( {E}_{γ} , i ) \cdot {( μ / ρ )}_{( m , j )}}{σ ( {E}_{γ} , i ) \cdot {ɛ}_{0} ( {E}_{γ} , i ) \cdot {( μ / ρ )}_{( m , i )}} \cdot \cdot \frac{1 - exp ( {( - \frac{μ}{ρ} )}_{( m , j )} \cdot {ρ}_{m} \cdot ( R - {d}_{s} ) )}{1 - exp ( {( - \frac{μ}{ρ} )}_{( m , i )} \cdot {ρ}_{m} \cdot ( R - {d}_{s} ) )} \cdot \frac{exp ( {( \frac{μ}{ρ} )}_{( s , i )} \cdot {ρ}_{s} \cdot {d}_{s} )}{exp ( {( \frac{μ}{ρ} )}_{( s , i )} \cdot {ρ}_{s} \cdot {d}_{s} )}$$

Therein, and j refer to various γ-lines of the same element to be quantified in the sample. The factor q_{i,j} can be determined from the basic condition that the quantification of the element with each of the γ-lines emitted by the element must always result in the same mass m of the element present in entirety in the sample. If this condition is not met, this is demonstrated in the chi-squared test as an error.

Advantageously, the expected ratio of the photopeak areas generated by various gamma lines of the element being sought in the sample is therefore taken into account in the assumption.

If there are no gamma-shielding structures in the sample, the gamma radiation emitted by the occurrence of the element in the sample is merely shielded by the matrix of the sample and by the enclosure (steel drum) serving as the calibration region. If the sought element in the sample, which is excited to emit gamma radiation, is homogeneously distributed and neutron flux in the sample is homogeneous, these two shielding mechanisms alone influence the ratio between P(E_{γ},i) and P(E_{γ},j). The test statistic χ² now measures the extent to which the actual ratio between P(E_{γ},i) and P(E_{γ},j) deviates from the ratio that was theoretically predicted in this manner. If there are no gamma-shielding structures in the sample, the value of χ² is minimal. If the value of χ² is below a critical threshold that depends on the significance level that was selected, then the hypothesis that the sample contains no gamma-shielding structures is correct with the probability associated with the selected significance level.

Shielding structures can be, for example, primary packaging made of lead and other shielding materials, in which the sought element was enclosed before being placed into a steel drum as the waste container. However, said shielding structures can also be other objects made of lead and other materials that are impenetrable to gamma radiation that accidentally enter the gamma radiation path between the occurrence of the sought element in the sample and the detector. This often takes place when a standard steel drum is used as a waste collection container for an entire collection of contaminated objects and is subsequently encased in concrete, for example.

The test for whether shielding structures are present can be carried out in the case of a rotated sample for each angle of rotation θ individually, or for the sum or the integral of all measurements carried out at all angles of rotation θ.

If it was determined that a gamma-shielding structure is present in the sample, then, in a further advantageous embodiment of the invention, the area of the photopeak can be calculated on the basis of a parametrized approach for the effect of the gamma-shielding structure, and the deviation of said area from the area obtained from measurement results can be minimized by varying the parameters. The parameters for which the deviation is minimized can then be used as characteristic values of the gamma-shielding structure. For example, a mean thickness and a mean density of the shielding can be selected as the parameters and varied in the discrete space. The deviation can be minimized using the chi-squared method in particular.

The following is suitable, for example, as the test statistic for the chi-squared test of the hypothesis that a shielding structure is present that has a mean thickness dₐ and a mean density ρₐ, and the remaining matrix of the sample has the density ρ_{q}:

$${χ}^{2} = {\sum }_{i , j} \frac{{( \frac{P ( {E}_{γ} , i )}{P ( {E}_{γ} , j )} - {q}_{i , j} ( {d}_{a} , {ρ}_{a} , {ρ}_{q} ) )}^{2}}{{q}_{i , j} ( {d}_{a} , {ρ}_{a} , {ρ}_{q} )}$$

for i≠j with

$${q}_{i , j} = \frac{σ ( {E}_{γ} , i ) \cdot {ɛ}_{0} ( {E}_{γ} , i ) \cdot {( μ / ρ )}_{( q , j )}}{σ ( {E}_{γ} , i ) \cdot {ɛ}_{0} ( {E}_{γ} , i ) \cdot {( μ / ρ )}_{( q , j )}} \cdot \frac{1 - exp ( {( - \frac{μ}{ρ} )}_{( q , j )} \cdot {ρ}_{q} \cdot ( R - {d}_{s} - {d}_{a} ) )}{1 - exp ( {( - \frac{μ}{ρ} )}_{( q , i )} \cdot {ρ}_{q} \cdot ( R - {d}_{s} - {d}_{a} ) )} \cdot \cdot \frac{exp ( {( \frac{μ}{ρ} )}_{( a , i )} \cdot {ρ}_{a} \cdot {d}_{a} )}{exp ( {( \frac{μ}{ρ} )}_{( a , j )} \cdot {ρ}_{a} \cdot {d}_{a} )} \cdot \frac{exp ( {( \frac{μ}{ρ} )}_{( s , i )} \cdot {ρ}_{s} \cdot {d}_{s} )}{exp ( {( \frac{μ}{ρ} )}_{( s , j )} \cdot {ρ}_{s} \cdot {d}_{s} )}$$

(μ/ρ)ₐ and (μ/ρ)_{q} are the mass attenuation coefficients of the shielding structure and of the rest of the materials contained in the sample. The entire sample therefore comprises two main fractions, namely the calibration region (steel drum), to which a density ρₛ and a thickness dₛ are allocated, and the matrix enclosed therein (for example, concrete filling with inclusions of the sought element) having a density ρₘ. The components of this matrix can now be identified more closely in the shielding structures, which are described via the mean density ρₐ and the mean thickness dₐ thereof, and a remainder having the mean density ρ_{q} can also be identified more closely.

Advantageously, the expected ratio of the photopeak areas generated by various gamma lines of the element being sought in the sample is therefore taken into account in the parametrized approach.

Findings from a previously conducted qualitative elemental analysis of the sample can be used to define or limit the parameters. If it was found, for example, that the sample contains high-density elements (such as lead or cadmium), this density of these elements is a possible starting value for the mean density ρₐ of the shielding.

In the simplified assumption that the shielding structure extends along the entire height of the sample (for example, a steel drum filled with waste), the density ρ_{q} of the remaining materials that are not part of the shielding structure can be expressed via the known mean density ρₘ of the entire matrix of the sample (for example, concrete as the filling material plus shielding structures and inclusions of the sought element) and via the mean density ρₐ of the shielding structure, which was obtained from the parameter optimization:

$${ρ}_{q} = {ρ}_{a} + \frac{{( R - {d}_{s} )}^{2}}{{( R - {d}_{s} - {d}_{a} )}^{2}} \cdot ( {ρ}_{m} - {ρ}_{a} ) .$$

This follows from the basic condition that the mean total density of the sample multiplied by the total volume of the sample must result in the known total mass of the sample.

If due to parameter optimization, the mean thickness dₐ and the mean density ρₐ of a shielding structure in the sample are known and if the rest of the matrix of said sample has the density ρ_{q}, there is a closed expression for the mass m of the element that is homogeneously distributed in said rest of the matrix:

$$m = \frac{M}{N \cdot σ ( {E}_{γ} ) \cdot Φ} \cdot \frac{P ( {E}_{γ} )}{{ɛ}_{0} ( {E}_{γ} ) \cdot {f}_{i} \cdot {F}_{0} \cdot } \cdot \frac{{( μ / ρ )}_{q} \cdot {ρ}_{q} \cdot {V}_{q}}{1 - exp ( {( - \frac{μ}{ρ} )}_{q} {ρ}_{q} \cdot ( R - {d}_{s} - {d}_{a} ) )} \cdot \cdot exp ( {( \frac{μ}{ρ} )}_{s} \cdot {ρ}_{s} \cdot {d}_{s} ) \cdot exp ( {( \frac{μ}{ρ} )}_{a} \cdot {ρ}_{a} \cdot {d}_{a} ) .$$

Therein, V_{q} is the volume of the sample that is neither part of the enclosure (steel drum) functioning as the calibration region nor of the shielding structure:

$${V}_{q} = \frac{{( R - {d}_{s} - {d}_{a} )}^{2}}{{( R - {d}_{s} )}^{2}} \cdot V$$

In a further particularly advantageous embodiment of the invention, the sample is rotated. The dependence of the gamma radiation emitted by the sample, more particularly the intensity thereof, on the angle of rotation is calculated on the basis of an assumption for the position of an element that is locally concentrated in the sample. The comparison of this angle-dependence with the angle-dependence obtained from measurement results is evaluated as a measure of the validity of the assumption.

In particular, the validity of the assumption can be evaluated using a chi-squared test of the deviation between the angle-dependence that was calculated and the angle-dependence obtained from measurement results.

The angle-dependence can be present, for example, as a plot of count rate versus the rotational angle, which can be normalized at the maximum of said curve in particular.

The sample can be cylindrical (a steel drum filled with waste), for example. For such a sample, the angle-dependent count rate distribution R(E_{γ},θ) can be simulated on the basis of the following assumptions, namely that:
at half the height of the sample, that is, in a plane with the neutron source and the detector, one gram of the sought element is locally concentrated in each of various positions (pᵢ, βᵢ), wherein pᵢ is the radial component of the position i and βᵢ is the azimuthal component of the position i;
in addition to the sought element, the sample contains shielding structures having a mean thickness dₐ and a mean density ρₐ; and
the rest of the matrix of the sample has the mean density ρ_{q}.

Expressed as a function of these parameters, R(E_{γ},θ) is.

$$R ( {E}_{γ} , θ ) = \frac{1}{M} \cdot N \cdot σ ( {E}_{γ} ) \cdot Φ \cdot {ɛ}_{0} ( {E}_{γ} ) \cdot exp ( - {( \frac{μ}{ρ} )}_{s} \cdot {ρ}_{s} \cdot {d}_{s} ) \cdot {\sum }_{( {p}_{l} , {β}_{l} )} {( \frac{{d}_{0}}{{d}_{i} ( θ )} )}^{2} \cdot exp ( - {( \frac{μ}{ρ} )}_{q} \cdot {ρ}_{q} \cdot {d}_{q} ( θ ) ) \cdot exp ( - {( \frac{μ}{ρ} )}_{a} \cdot {ρ}_{a} \cdot {d}_{a} ( θ ) ) \cdot {ω}_{i} ( θ ) .$$

Therein, dᵢ(θ) is the distance between the detector (for example, an HPGe detector) and the locally concentrated occurrence of the sought element at the position i. This simulated count rate distribution R(E_{γ},θ) can be compared to the count rate distribution obtained from the measurement results for the net photopeak areas:

Z(E_{γ},θ)=P(E_{γ},θ)/fₜ

Advantageously, the dependence of the gamma radiation emitted by the sample, more particularly the intensity thereof, on the rotational angle is calculated on the basis of a parametrized approach for the position of the locally concentrated element in the sample, and the deviation from the angle-dependence obtained from measurement results is minimized by varying the parameters. The deviation can be minimized using the chi-squared method in particular.

For example, the aforementioned expressions for the simulated angle-dependent count rate R(E_{γ},θ) and for the angle-dependent count rate Z(E_{γ},θ) obtained from measurement results can be combined to form a chi-squared test statistic:

$${χ}^{2} = {\sum }_{θ}^{n} {( \frac{R ( {E}_{γ} , θ )}{{R ( {E}_{γ} , θ )}_{max}} - \frac{Z ( {E}_{γ} , θ )}{{Z ( {E}_{γ} , θ )}_{max}} )}^{2}$$

wherein n=360/Δθ indicates the fineness of the angular gradation. R(E_{γ},θ)ₘₐₓ and Z(E_{γ},θ)ₘₐₓ are the maximum of the count rate that was simulated and the maximum of the count rate that was obtained from measurement results, respectively, at which the count rates for the comparison are normalized. χ² depends only on the parameters ρᵢ, βᵢ, ρ_{q}, ρₐ, and dₐ as unknowns. The values of the parameters for which χ² is minimized are the values that are actually present in the sample with the probability associated with the selected significance level.

In a further particularly advantageous embodiment of the invention, the diameter of a sphere made of the element, wherein said sphere, if placed at the location of the local concentration of the element in the sample, would exhibit the measured dependence of emitted gamma radiation on the rotational angle is calculated. Next, the total mass m of the element locally concentrated in the sample is evaluated on the basis of the comparison of said diameter with the diameter of a reference sphere made of the element, the mass of which is known.

In this manner, the fact that a local concentration of the element has a finite spatial distribution can be taken into account in the quantification of the mass m. If gamma radiation is emitted in the interior of said local concentration in response to irradiation with neutrons, a portion of said gamma radiation is reabsorbed by the element itself and does not reach the detector. If this self-absorption is not taken into account, the quantification of the mass m has a systematic error. Said systematic error is greater, the more expanded the local concentration of the element in the sample is, and the better the element absorbs gamma radiation is. This is pronounced in particular when the sought element is a heavy metal such as lead or cadmium.

According to the invention, the spherical geometry for the sought element is now calculated, the gamma radiation of which exhibits the same angle-dependence as the actual locally concentrated occurrence of the sought element in the sample. The self-absorption can be calculated particularly easily for spherical geometries, thereby making it possible to correct this out in the quantification of the mass m.

The diameter D of the equivalent sphere is obtained as follows:

$$\frac{{\sum }_{θ}^{n} Z ( {E}_{γ} , θ )}{{\sum }_{θ}^{n} {R ( {E}_{γ} , θ )}_{{χ}_{min}^{2}}^{{p}_{i} , {β}_{l} , {p}_{q} , {p}_{a} , {d}_{a}}} = ρ \frac{4}{3} \cdot π \cdot {( \frac{D}{2} )}^{3} \cdot F ( {E}_{γ} , D )$$

Therein, that angle-dependent count rate distribution is used for R(E_{γ},θ) for which the test statistic χ² is minimized in the comparison with the count rate distribution obtained from measurement results. ρ is the density of the sought element and is known. F(E_{γ},D) is the self-absorption factor of a sphere that has diameter D and is made of the sought element, given gamma energy E_{γ}. This factor is given by:

$$F ( {E}_{γ} , D ) = \frac{3 [ \begin{matrix}1 - \frac{2}{{( μ ( {E}_{γ} ) \cdot D )}^{2}} + \\ exp ( - μ ( {E}_{γ} ) \cdot D ) \cdot ( \frac{2}{μ ( {E}_{γ} ) \cdot D} + \frac{2}{{( μ ( {E}_{γ} ) \cdot D )}^{2}} )\end{matrix} ]}{2 μ ( {E}_{γ} ) \cdot D}$$

μ(E_{γ}) for the element sought in the sample is known from tables. It is therefore possible to express F(E_{γ},D) as a function of D using a parametrized approach:

$$F ( {E}_{γ} , D ) = \frac{1 + a ( {E}_{γ} ) \cdot D}{1 + b ( {E}_{γ} ) \cdot D + c ( {E}_{γ} ) \cdot {D}^{2}} .$$

If both expressions for F(E_{γ},D) are calculated as a function of D, the comparison (fit) yields the constants a(E_{γ}), b(E_{γ}), and c(E_{γ}), in which, inter alia, μ(E_{γ}) is contained, said constants being dependent only on the gamma energy. The parametrized approach is clearly a better approach for the numerical determination of the sought sphere diameter D, although it has a slight error in the fit.

Advantageously, the sphere that is selected as the reference sphere is such that said sphere, if placed at the location of the local concentration of the element in the sample, would exhibit the same dependence of measured gamma radiation on the rotational angle as would a cylinder that is made of the element, has the specified geometry, and is located at that very point.

To this end, it would basically be necessary to calculate reference spheres for various cylinders until a reference sphere is obtained that has a diameter corresponding to the diameter D of the equivalent sphere determined from the measured data. This would require a longer computation time, which would be burdensome in serial measurements. However, the problem can be simplified in that maximum values for the length and for the diameter of a hypothetical cylinder made of the sought element are specified via the dimensions of the sample and the specified position of the cylinder at the polar coordinates (pᵢ,βᵢ) in the cylindrical sample (a drum filled with waste).

It now makes sense to calculate the diameter of the corresponding reference sphere for all possible cylinder dimensions given the additional basic condition that all cylinders should have the same volume and, therefore, the same specified mass (unit mass) m_{ref}. In the quantity of said cylinders there is now a reference sphere having a smallest diameter Dₘᵢₙ and a reference sphere having a greatest diameter Dₘₐₓ. If the diameter D of the equivalent sphere, which is obtained from the measured data, is between Dₘᵢₙ and Dₘₐₓ, this means that the unit mass m=m_{ref} of the sought element is precisely locally concentrated in the sample. If D is outside this range, the sought mass m of the locally concentrated element in the sample results from the equation:

$$m = {m}_{ref} \cdot \frac{{\sum }_{θ}^{n} Z ( {E}_{γ} , θ )}{\overline{{Z}_{ref} ( {E}_{γ} )}} \cdot {( \frac{F ( {E}_{γ} , \overline{{D}_{ref}} )}{F ( {E}_{γ} , D )} )}^{\frac{1}{2}} .$$

Therein, the count rate Z̅_̅{̅r̅e̅f̅}̅(̅E̅_̅{̅λ̅}̅)̅ and the diameter D̅_̅{̅r̅e̅f̅}̅ of the sphere that is equivalent to the cylinder are averaged for all the cylinders tested.

The uncertainty σₘ in the determination of the mass m of the element is determined using the following equation:

$${σ}_{m} = \sqrt{{( σ ( \overline{{Z}_{ref} ( {E}_{γ} )} ) )}^{2} + {( σ ( {χ}_{min}^{2} ) )}^{2}}$$

Therein, σ( Z̅_̅{̅r̅e̅f̅}̅(̅E̅_̅{̅λ̅}̅)̅) is the standard deviation of Z̅_̅{̅r̅e̅f̅}̅(̅E̅_̅{̅λ̅}̅)̅ and σ(χₘᵢₙ²) is the standard deviation of the chi-squared fit for the minimal value of the test statistic χ². σ( Z̅_̅{̅r̅e̅f̅}̅(̅E̅_̅{̅λ̅}̅)̅) contains the uncertainty for the unknown axial position of the element, that is, the uncertainty regarding the height at which the sought element is enclosed in the drum.

In a particularly advantageous embodiment of the invention, the gamma radiation is measured in the time interval after a neutron pulse in which at least 50%, preferably at least 75% and, very particularly preferably, at least 90%, of the neutrons of the pulse are moderated to energies between 100 eV and 1 KeV.

It was found that the gamma radiation that is excited by the neutron pulse and emitted by the sample comprises components that originate from different physical interaction mechanisms. These components are not all emitted simultaneously, but rather one after the other in a temporal sequence.

At first, all the neutrons impacting the sample are fast. A portion of said fast neutrons excites atomic nuclei in the sample to promptly emit gamma radiation. A further part of the neutrons convert atomic nuclei in the sample into radionuclides having different half-lives, which do not emit gamma radiation until substantially later due to the radioactive decomposition thereof. A further portion of the neutrons is moderated into the claimed energy range via interaction with lightweight elements in the sample or also with the wall of the sample chamber.

The moderated neutrons now excite further atomic nuclei in the sample to promptly emit gamma radiation in that they are captured by said atomic nuclei, and/or these convert further atomic nuclei into radionuclides. Compared to the reactions that are triggered directly by the fast neutrons, these reactions are delayed by the time period corresponding to the duration of the moderation into the claimed range. Therefore, the prompt gamma radiation originating from the slow neutrons does not result in a significant contribution to all the gamma radiation registered by the detector until the contribution originating from the fast neutrons has died out once more.

The radionuclides formed by the neutron irradiation in the sample do not start emitting gamma radiation until substantially later. This is also so weak that it retreats entirely behind the prompt gamma radiation originating from the moderated neutrons.

Therefore, after one neutron pulse, there is a time window in which practically all the gamma radiation registered by the detector is prompt gamma radiation that originates from the neutrons moderated into the claimed range. If measurement is carried out in this time window, the time factor fₜ in the formula for the net photopeak area P(E_{γ}) is therefore fixed from the start and no longer causes any noteworthy inaccuracy in the quantification of the sought element in the sample.

The time window typically has a width of a few milliseconds. It typically opens 200 μS after the end of the neutron pulse. By that time, activation of the wall of the sample chamber, which is made of graphite, for example, has also typically died out, said activation having been induced by the fast neutrons. Said time window closes in as the neutrons initially moderated into the claimed energy range are further moderated into lower energy range, and therefore less than 50% (preferably 75%, very particularly preferably 90%) of the neutrons of the pulse remain in the claimed energy range.

In a particularly advantageous embodiment of the invention, the gamma radiation is also measured in the time interval after a neutron pulse in which at least 50%, preferably at least 75% and, very particularly preferably, at least 90%, of the neutrons of the pulse are moderated to energies below 1 eV. At this point in time, there are hardly any neutrons left having sufficient energy to excite the emission of prompt gamma radiation. The gamma radiation registered by the detector then originates practically only from the longer-life radionuclides that were formed by the neutron irradiation.

This delayed gamma radiation can therefore be detected in a manner physically separated from the prompt gamma radiation by waiting until the prompt gamma radiation has died out. This can therefore be used for the quantification of the sought element from the net photopeak area using a time factor fₜ dedicated thereto, which differs from the time factor fₜ for the prompt gamma radiation. However, if prompt and delayed gamma radiation are detected jointly and are separated from one another afterward using a deconvolution method, additional computing time is required therefor, which is burdensome for a serial examination of several samples. In addition, as a side effect, a deconvolution method amplifies any noise that contaminates the raw data, to a significant error in the final results for the prompt and delayed gamma radiation. Since the two radiations are detected separately from the start by way of temporally separated detection, these disadvantages are avoided.

The duration for which the delayed gamma radiation is measured depends on which radionuclides formed by the neutron burst are intended to be detected. Various radionuclides can differ from one another by way of the half-lives thereof. For example, the delayed gamma radiation of short-lived radionuclides between two neutron pulses can be measured for a duration of a few milliseconds. After the irradiation has ended, the delayed gamma radiation of longer-lived radionuclides can be measured for a time period of a few minutes to hours.

The claimed energy range of the neutrons, of 100 eV to 1 KeV, is particularly advantageous when the sample contains materials such as cadmium, boron, or mercury, which absorb thermal neutrons to a very great extent. In said range, a sufficient nuclear cross section exists for the capture of the neutrons, which results in the emission of prompt gamma radiation. At the same time, however, the neutrons also penetrate metallic inclusions, and so these do not result in shadowing effects.

It is particularly important to distinguish between prompt and delayed gamma radiation when the sample contains a mixture of several elements. If the sample contains arsenic and cadmium, for example, the main line of the prompt gamma radiation of cadmium having the strongest intensity, therefore, has the same energy as the main line of the delayed gamma radiation of arsenic having the strongest intensity. The fact that prompt and delayed gamma radiation is detected separately makes it possible to reliably distinguish between the two elements.

Analogously, it is also possible to separately detect the prompt gamma radiation originating from fast neutrons. To this end, the gamma radiation must be measured at a point in time at which at least 50% of the neutrons of the pulse are moderated to energies between 100 eV and 1 KeV.

This measurement is technically challenging, however, since the prompt gamma radiation excited by the fast neutrons is stronger by several orders of magnitude than the prompt gamma radiation excited by the moderated neutrons, and every detector has a limited dynamic range between the response threshold and saturation.

The gamma radiation can be measured spectroscopically in particular, that is, sorted according to energies of the individual events. The count rates of the detector at the energies that are investigated are then advantageously accumulated across a certain number of neutron pulses in order to increase the statistical validity thereof.

Advantageously, the sample is irradiated with neutrons having energies above 10 MeV. For example, an electronic D-T neutron generator delivers neutron energy of 14 MeV. Neutrons in this energy range can penetrate large-volume samples to a particularly deep extent in order to be moderated there.

In a particularly advantageous embodiment of the invention, at least a portion of the neutrons that penetrate the sample is reflected back into the sample. The sample can then be excited to emit stronger gamma radiation using a given rate of neutrons that delivers the neutron source per second. This is advantageous, in particular, when the elements to be determined in the sample have a small nuclear cross section for neutrons.

Another result of the reflection is that the interior of the sample is acted upon by slow neutrons in a more homogeneous manner overall. This applies in particular when the sample is brought into a sample chamber in which the neutrons can be reflected multiple times.

A device for carrying out the method according to the invention was also developed within the scope of the invention. Said device comprises a sample chamber for accommodating the sample to be examined, a pulsed neutron source for irradiating the sample, and a detector for the gamma radiation emitted by the sample.

According to the invention, the sample chamber is surrounded by a neutron-reflecting material, which is capable of reflecting neutrons that are not absorbed by the sample back into the sample chamber.

It was found that, in a sample chamber, the neutrons from the neutron source that are not absorbed by the sample on the first pass can be reflected through the sample one or many times, thereby simultaneously enabling said neutrons to be moderated in a stepwise manner.

A time program is therefore produced, according to which the neutrons are moderated. According to said time program, the time interval or time intervals in which the gamma radiation is measured can be defined as the method according to the invention is carried out.

If the material has sufficient thickness, the moderation of the neutrons by said material is definitely the dominating effect compared to moderation in the sample itself. Therefore, the time program for the moderation of the neutrons is substantially determined only via the properties of the sample chamber and not via the properties of the sample. This is particularly advantageous for serial measurements performed on a plurality of samples. In a serial measurement, it is time-consuming, and therefore disadvantageous, to have to adjust parameters for every new sample before the actual measurement. If the condition of the sample chamber is now dominant for the moderation of the neutrons, then there is a standard setting for the time interval at which a good result is always obtained. In order to make this result even better, the position of the time window on the time axis can be adapted via fine optimization to the influence of the sample on the moderation. The standard setting provides a meaningful starting point for said fine optimization.

In a particularly advantageous embodiment, graphite is the neutron-reflecting material. Beryllium would also be suitable in principle, but this is expensive, highly toxic, and not freely available in relatively large quantities due to the basic suitability thereof as a neutron reflector for nuclear weapons.

In a further advantageous embodiment of the invention, the detector is disposed relative to the sample chamber such that the sample fills a solid angle of at most 0.6 steradian, as viewed from the detector. It is thereby ensured that a sufficient portion of the gamma radiation from every location in the sample falls within the acceptance angle of the detector and can be registered by the detector. The detector can then simultaneously register gamma radiation from all regions of the sample, thereby eliminating the need to move the sample past the detector in a scanning manner. Such a scanning motion makes interpret ng the measurement results difficult since said measurement results always relate to different, partially overlapping spatial regions of the sample and must be subsequently combined to obtain a total view of the sample. In addition, the actuating elements for a scanning motion (such as a lifting device) usually contain metal, which is activated by the neutron irradiation and results in an additional background signal on the detector. The distance at which the sample should be placed from the detector is determined on the basis of the specified solid angle of 0.6 steradian, as the maximum, and the geometric dimensions of the sample (a 200-liter waste drum, for example). In addition, the detector must be collimated at the range that is relevant in terms of the scanning. This is usually achieved via shielding against the high-energy gamma radiation from the region of the sample that is not relevant at the moment. Shielding material, which is activated by the neutron irradiation and henceforth adds a background signal to the measurement signal, is required in large quantities. If the shielding is made of lead, for example, detecting lead in the sample being examined is difficult.

In a further advantageous embodiment of the invention, the detector comprises: a primary detector for the gamma radiation emitted by the sample; a secondary detector, which at least partially surrounds the primary detector; and means for an anticoincidence circuit of the primary detector and the secondary detector. The energy of the gamma quanta emitted by the sample is not always stored completely in the primary detector if a gamma-quantum is not absorbed there but is rather merely Compton-scattered. The thinner the primary detector is, the greater the number of Compton-scattered gamma quanta that can leave the primary detector is, and therefore a portion of the energy thereof remains unaccounted for in the energy measurement. The secondary detector is now used to register precisely these gamma quanta that escaped. If the primary and secondary detectors respond within a gate time, then, in the anticoincidence measurement, both events are assumed to be due to the Compton-scattering of a gamma quantum in the primary detector. These events are then discarded. The secondary detector need not have a high energy resolution; this merely needs to register whether or not a gamma quantum arrives. Said secondary detector must therefore have good absorptive power for high-energy gamma radiation. To ensure that false coincidence events are not registered, the secondary detector must be well shielded against the gamma radiation emitted by the sample and against the neutrons from the neutron source.

The small solid angle filled by the sample also indirectly induces a reduced error in the quantification of elements in the sample. If the total quantity of an element present in the sample is calculated via the area under a photopeak, the distribution of the element in the sample is incorporated in the photopeak efficiency. The radial distribution in the sample can be determined by rotating the sample about an axis, although the axial distribution along the rotational axis is unknown and results in residual uncertainty. The lower the height of the sample is along the rotational axis relative to the distance to the detector, the lower said residual uncertainty becomes.

Advantageously, the detector has a neutron shielding made of ⁶Li. This is sufficiently transparent for the gamma radiation emitted by the sample in the relevant energy ranges and also absorbs slow neutrons without being excited thereby to emit gamma radiation.

Advantageously, the detector is disposed relative to the neutron source such that said detector can only be reached by neutrons that were reflected multiple times. These neutrons are also simultaneously moderated to lower energies by way of the multiple reflection, especially when graphite or another neutron-reflecting material is used that is also suitable as a neutron moderator. Said neutrons can then be captured in the shielding.

Fast neutrons would pass through the shielding and result in radiation damage in the detector.

Advantageously, the device comprises a rotary table for the sample. Said rotary table can adjoin the sample in particular by way of a material, such as carbon-fiber reinforced plastic, that cannot be activated by neutron bombardment, or only poorly so. As a result, an additional background signal is advantageously prevented.

### SPECIFIC DESCRIPTION

The subject matter of the invention is explained in the following in greater detail with reference to figures, without the subject matter of the invention being limited thereby. Shown are:

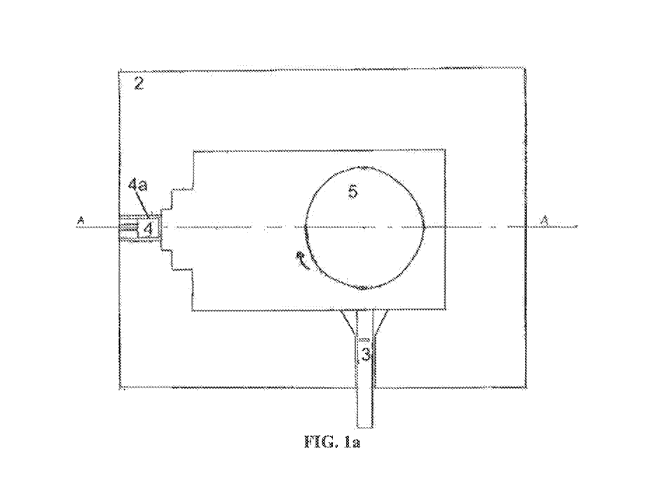

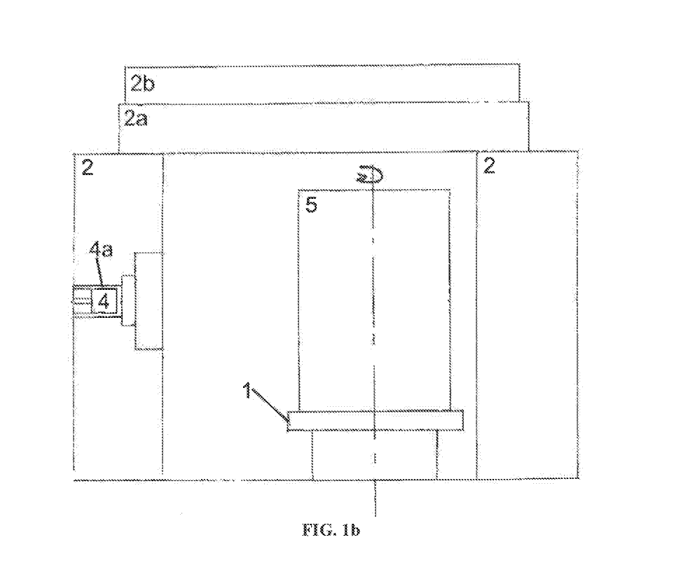

FIG. 1: shows an exemplary embodiment of the device according to the invention in a top view (a) and in a sectional drawing along the line A-A in FIG. 1a (b).

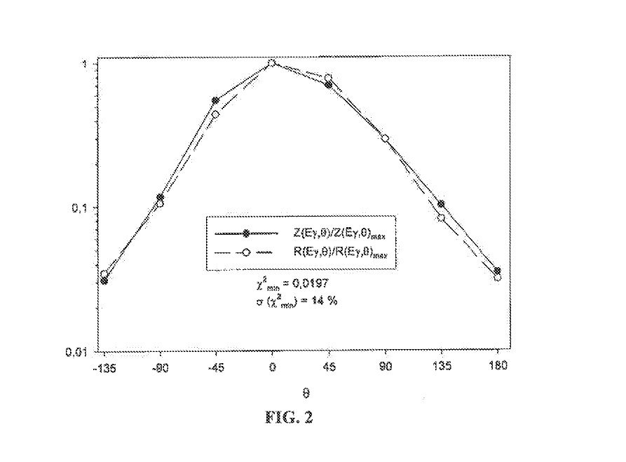

FIG. 2: shows a chi-squared fit of the normalized count rate distribution for a 500 cm³ Pb cylinder (r=3.26 cm/h=15 cm) at a radial position of 14 cm from the center of the drum.

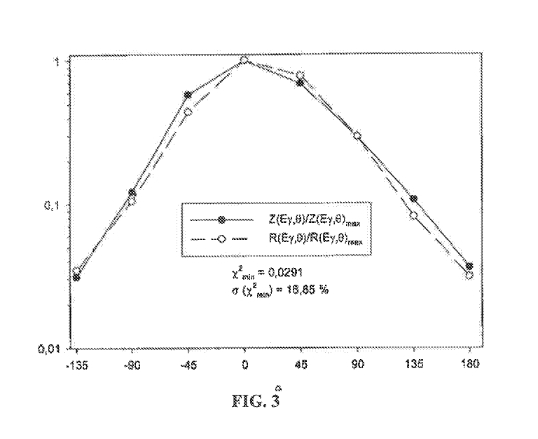

FIG. 3: shows a chi-squared fit of the normalized count rate distribution for a 5000 cm³ Pb cylinder (r=7.98 cm/h=25 cm) at a radial position of 14 cm from the center of the drum.

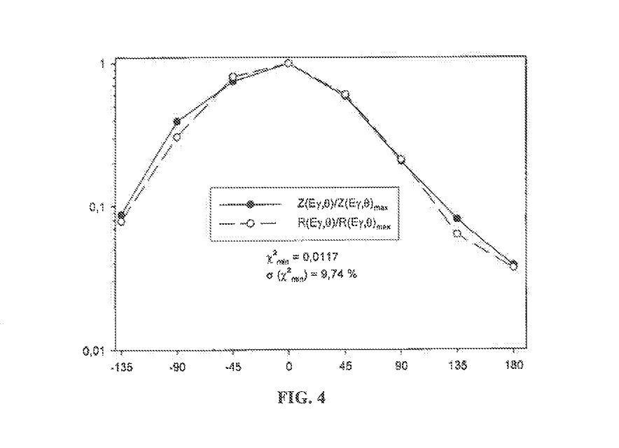

FIG. 4: shows a chi-squared fit of the normalized count rate distribution for two 500 cm³ Pb cylinders (r=3.26 cm/h=15 cm) at a radial position of 14 cm from the center of the drum and an angular distance of 45° between the cylinders.

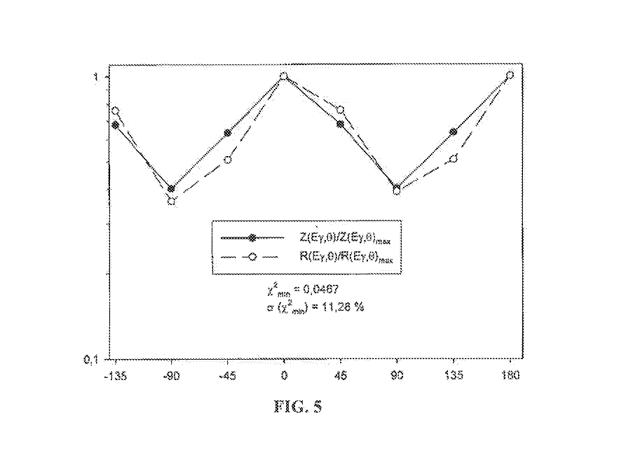

FIG. 5: shows a chi-squared fit of the normalized count rate distribution for two 500 cm³ Pb cylinders (r=326 cm/h=15 cm) at a radial position of 14 cm from the center of the drum and an angular distance of 180° between the cylinders.

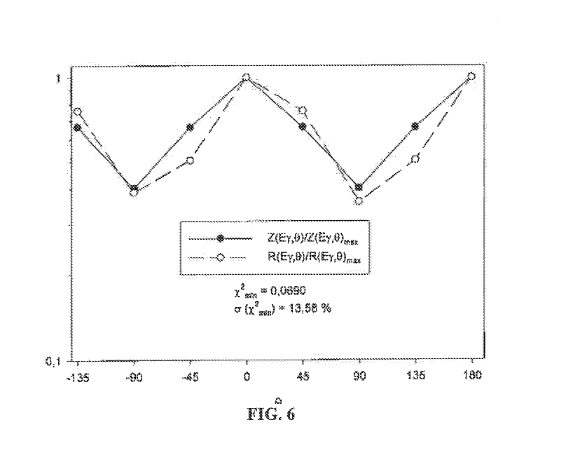

FIG. 6: shows a chi-squared fit of the normalized count rate distribution for two 5000 cm³ w Pb cylinders (r=7.98 cm/h=25 cm) at a radial position of 14 cm from the center of the drum and an angular distance of 180° between the cylinders.

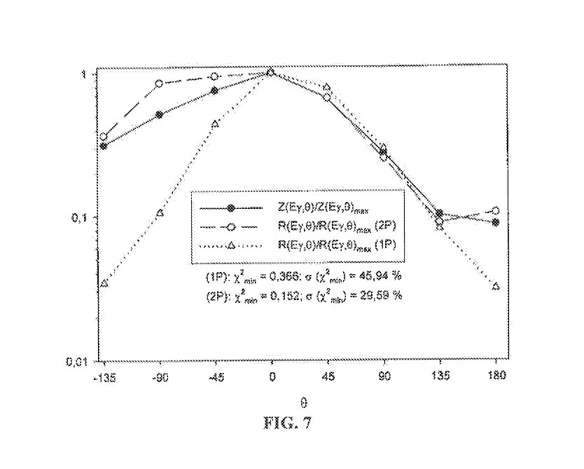

FIG. 7: shows a chi-squared fit of the normalized count rate distribution for two 1000 cm³ Pb cylinders (r1=2 cm/h1=80 cm; r2=14 cm/h2=1.62 cm) at a radial position of 14 cm from the center of the drum and an angular distance of 90° between the cylinders.

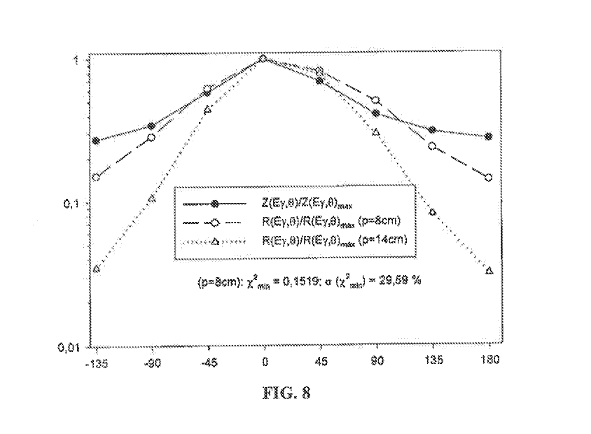

FIG. 8: shows a chi-squared fit of the normalized count rate distribution for a 1000 cm³ Pb cylinder (r=2 cm/h=80 cm) at a radial position of 14 cm from the center of the drum and a 5000 cm³ Pb cylinder (r=7.98 cm/h=25 cm) in the center of the drum.

FIG. 1 shows an exemplary embodiment of the device according to the invention. Sectional image a shows a top view. Sectional image b is a sectional drawing, wherein the section along the line A-A drawn in sectional image a was shown. A rotary table 1 for accommodating the sample 5 is disposed within a graphite chamber 2 having a wall thickness of 40 cm, said graphite chamber functioning as a neutron reflector. The interior of the graphite chamber 2 is 80 cm wide, 140 cm long and 140 cm high. The graphite chamber has a cover comprising a plate 2a made of carbon-fiber reinforced plastic having graphite 2b disposed thereupon.

In the graphite chamber 2, the sample on the rotary table 1 can be acted upon by neutrons from the D-T neutron generator 3. The distance between the center of the sample 5 and the tritium target of the D-T neutron generator 3, which is 55 cm, is selected such that the neutrons isotropically emitted from the tritium target induce adequate flux everywhere in the sample 5. To this end, the neutron generator 3 is positioned in a wall of the graphite chamber 2 at half the height of the sample 5 (open geometry). There is no direct visual contact between the neutron generator 3 and the HPGe detector 4.

As a result, the detector 4 can only be reached by neutrons that were reflected and thereby moderated in the graphite chamber 2 multiple times. Said detector is therefore not impacted by fast neutrons, which penetrate the ⁶Li shield 4a thereof and would cause radiation damage. The HPGe detector 4 is also positioned in a wall of the graphite chamber 2 at half the height of the sample 5 (open geometry), offset by 90° relative to the neutron generator 3. The distance between the center of the sample 5 and the HPGe detector (with a relative efficiency of 100%) 4, which is 100 cm, is selected such that a sufficient portion of the gamma radiation isotropically emitted from every point in the sample 5 falls within the acceptance angle of the detector 4 and contributes to the detector signal.

The neutron generator is operated in a pulsed manner.

In the following, a few examples of samples are used to simulate the experimental data that would be expected upon carrying out the method according to the invention and what the method according to the invention would yield in each case as the mass m of the sought element in the sample, as the final result. In each case, this mass m is compared to the mass of the element actually contained in the sample according to the simulation assumption.

Table 1 lists the angle-dependent count rate distributions for lead cylinders having different shapes that would result (Z(E_{γ},θ) in counts/second) from a measurement and that would be theoretically predicted (R(E_{γ},θ) in counts/second/gram lead) according to the simplifying assumptions mentioned above. The count rates were calculated for a gamma energy of 1064 keV (nuclide Pb-207m) for cylinders, each of which has a volume of 1000 cm³ (ρ=11.34 g/cm³; m_{ref}=11.34 kg), and which differ from one another in terms of the radii and lengths (r and h, respectively, both given in cm) thereof. Each of the cylinders is embedded in a 200-liter standard drum filled with a concrete matrix at a radial position of 14 cm from the center of the drum. These lie in a plane at half the height of the drum and, therefore, in a plane with the neutron source and the detector. The maximum length of the cylinder is fixed at 80 cm for a drum having a height of 86 cm. The maximum diameter of the cylinder is 28 cm and is equal to the radius of the drum. The density of concrete is 1.5 g/cm³.

The count rate distributions are bound to the assumed radial position at which the sought element in the sample is located. If this assumption changes, a new calibration set of that type should be calculated. The total mass m of the sought element in the sample that is obtained at the end of the evaluation deviates more strongly from the true total mass of the element when the difference between the assumed and the true radial position of the element in the sample increases. The radial position of the element in the sample can be determined via an analysis of the angle-dependent count rate distribution.

TABLE 1

| | Z(Ε_{γ},θ) c/s | | | | | | | |
|---|---|---|---|---|---|---|---|---|
| θ | r = 2/h = 80 | r = 2.30/h = 60 | r = 2.82/h = 40 | r = 4/ | r = 5.64/h = 10 | r = 8.92/h = 4 | r = 14/h = 1.62 | R(Ε_{γ},θ) c/s/g |
| 0 | 2.055 | 1.9500 | 1.749 | 1.420 | 1.147 | 0.942 | 0.921 | 4.727 10⁻⁴ |
| 45 | 0.869 | 0.8240 | 0.738 | 0.595 | 0.487 | 0.406 | 0.412 | 1.783 10⁻⁴ |
| 90 | 0.2985 | 0.2830 | 0.254 | 0.206 | 0.171 | 0.1496 | 0.178 | 4.920 10⁻ [symbol] |
| 135 | 0.1009 | 0.0959 | 0.0863 | 0.0702 | 0.0581 | 0.0502 | 0.0571 | 1.886 10⁻ [symbol] |
| 180 | 0.0896 | 0.0854 | 0.0769 | 0.0622 | 0.0510 | 0.0426 | 0.0436 | 2.078 10⁻ [symbol] |
| 225 | 0.3407 | 0.324 | 0.291 | 0.237 | 0.196 | 0.169 | 0.193 | 6.369 10⁻ [symbol] |
| 270 | 1.615 | 1.531 | 1.375 | 1.116 | 0.926 | 0.809 | 0.963 | 2.662 10⁻ [symbol] |
| 315 | 2.9.35 | 2.781 | 2.463 | 2.010 | 1.644 | 1.371 | 1.393 | 6.023 10⁻ [symbol] |
| ${\sum }_{\text{?}}^{\text{?}}$ | 8.304 | 7.8743 | 7.0322 | 5.7164 | 4.6801 | 3.9394 | 4.1607 | 1.672 10⁻ [symbol] |
| D (cm) | 20.63 | 20.11 | 19.01 | 17.14 | 15.99 | 14.25 | 14.64 | |

[symbol]

indicates data missing or illegible when filed

D is the diameter of the sphere, the emission behavior of which is equivalent to that of the particular cylinder under consideration. The parameters for the self-absorption of 1064 keV in Pb are: a(E_{γ})=0.1397; b(E_{γ})=0.4098; and c(E_{γ})=0.0737.

The mean count rate is Z̅_̅{̅r̅e̅f̅}̅(̅E̅_̅{̅λ̅}̅)̅=5.958±1.795 c/s. This results in a mean diameter of the equivalent sphere of D̅_̅{̅r̅e̅f̅}̅=17.49 cm.

The sphere diameters are between Dₘᵢₙ=14.25 cm and Dₘₐₓ=20.63 cm.

### EXAMPLE 1

Determination of the mass of a 500 cm³ Pb cylinder having a radius of 3.26 cm and a length of 15 cm. The cylinder lies in a plane at half the height of the drum at a radial position of 14 cm from the center of the drum. The count rates as a function of the rotational angle θ are summarized in table 2, R(E_{γ},θ) is given for the values of position (pᵢ/βᵢ) in the sample; density pₐ and thickness dₐ of a shielding structure and density p_{q} of the rest of the sample material for which the comparison with Z(E_{γ},θ) via a chi-squared test given a standard deviation σ of 14% yields a minimum value of the test statistic χ². The comparison of the angle-dependences of R(E_{γ},θ) and Z(E_{γ},θ), which have been normalized to the maximum R(E_{γ},θ)ₘₐₓ and Z(E_{γ},θ)ₘₐₓ thereof, respectively, is shown in FIG. 2.

In order to illustrate the method, part of the simulation assumption in this example and in the further examples is that the sample contains only concrete as the filler, without additional shielding structures. Therefore, pₐ=0 and dₐ=0.

TABLE 2
Count rates for a 500 cm³ Pb cylinder (r = 3.26 cm/h = 15 cm) at a radial position of 14 cm from the center of the drum.

| θ | 0 | 45 | 90 | 135 | 180 | 225 | 270 | 315 | ${\sum }_{\text{?}}^{\text{?}}$ |
|---|---|---|---|---|---|---|---|---|---|
| Z(Ε_{γ},θ) | 0.810 | 0.342 | 0.118 | 0.0402 | 0.0357 | 0.1356 | 0.638 | 1.1548 | 3.275 |
| c/s | | | | | | | | | |
| R(Ε_{γ},θ) | 4.727 | 1.783 | 4.920 | 1.886 | 2.078 | 6.369 | 2.662 | 6.023 | 1.672 10⁻⁴ |
| c/s/g | 10⁻⁴ | 10⁻⁴ | 10⁻ [symbol] | 10⁻ [symbol] | 10⁻ [symbol] | 10⁻ [symbol] | 10⁻⁴ | 10⁻⁴ | |

[symbol]

indicates data missing or illegible when filed

The diameter of the reference sphere, the gamma radiation of which has the same angle-dependence as R(E_{γ},θ), is D=13.00 cm and is outside the interval [Dₘᵢₙ,Dₘₐₓ]. m therefore results from the reference mass m_{ref} by way of the above-described scale with the count rate and the self-absorption, each on the basis of the mean values of all reference spheres considered in table 1. The mass of the cylinder is therefore determined to be 5.39±1.79 kg, which conforms well to the “true” value of 5.67 kg according to the simulation assumption.

### EXAMPLE 2

Determination of the mass of a 5000 cm³ Pb cylinder having a radius of 7.98 cm and a length of 25 cm. The cylinder lies in a plane at half the height of the drum at a radial position of 14 cm from the center of the drum. The count rates as a function of the rotational angle θ are summarized in table 3. The chi-squared fit of the normalized count rate distribution is shown in FIG. 3. Otherwise the procedure is identical to example 1.

TABLE 3
Count rates for a 5000 cm³ Pb cylinder (r = 7.98 cm/h = 25 cm) at a radial position of 14 cm from the center of the drum.

| θ | 0 | 45 | 90 | 135 | 180 | 225 | 270 | 315 | ${\sum }_{\text{?}}^{\text{?}}$ |
|---|---|---|---|---|---|---|---|---|---|
| Z(Ε_{γ},θ) | 4.846 | 2.078 | 0.753 | 0.253 | 0.218 | 0.856 | 4.076 | 7.018 | 20.098 |
| c/s | | | | | | | | | |
| R(Ε_{γ},θ) | 4.727 10⁻⁴ | 1.783 10⁻⁴ | 4.920 10⁻ [symbol] | 1.886 10⁻ [symbol] | 2.078 10⁻ [symbol] | 6.369 10⁻ [symbol] | 2.662 10⁻⁴ | 6.023 10⁻⁴ | 1.672 10⁻ [symbol] |
| c/s/g | | | | | | | | | |

[symbol]

indicates data missing or illegible when filed

The diameter of the reference sphere is D=32.19 cm and is outside the interval [Dₘᵢₙ,Dₘₐₓ]. By scaling the reference mass with count rates and self-absorption, the mass no of the cylinder is determined to be 52±18 kg. This conforms well to the “true” value of 56.7 kg according to the simulation assumption.

### EXAMPLE 3

Determination of the total mass of two 500 cm³ Pb cylinders having radii of 3.26 cm and lengths of 15 cm. The cylinders lie in a plane at half the height of the drum at a radial position of 14 cm from the center of the drum. The angular positions of the two cylinders lie in this plane, separated by 45°. Otherwise the procedure is identical to example 1. The count rates as a function of the rotational angle θ are summarized in table 4. The chi-squared fit of the normalized count rate distribution is shown in FIG. 4.

TABLE 4
Count rates for two 500 cm³ Pb cylinders (r = 3.26 cm/h = 15 cm) at a radial position of 14 cm from the center of the drum
and an angular distance of 45° between the cylinders.

| θ | 0 | 45 | 90 | 135 | 180 | 225 | 270 | 315 | ${\sum }_{\text{?}}^{\text{?}}$ |
|---|---|---|---|---|---|---|---|---|---|
| Z(Ε_{γ},θ) | 1.1522 | 0.401 | 0.1582 | 0.0759 | 0.1713 | 0.7736 | 1.4738 | 1.695 | 6.171 |
| c/s | | | | | | | | | |
| R(Ε_{γ},θ) | 6.510 10⁻⁴ | 2.275 10⁻⁴ | 6.806 10⁻ [symbol] | 3.964 10⁻ [symbol] | 8.447 10⁻ [symbol] | 3.2989 10⁻ [symbol] | 8.6848 10⁻⁴ | 1.075 10⁻⁴ | 3.344 10⁻ [symbol] |
| c/s/g | | | | | | | | | |

[symbol]

indicates data missing or illegible when filed

The diameter of the reference sphere is D=12.63 cm and is outside the interval [Dₘᵢₙ,Dₘₐₓ]. The total mass of the cylinder calculated via scaling the reference mass with count rates and self-absorption is 10.0±3.2 kg and conforms well to the “true” value 11.34 kg according to the simulation assumption.

### EXAMPLE 4

Determination of the total mass of two 500 cm³ Pb cylinders having radii of 3.26 cm and lengths of 15 cm. The cylinders lie in a plane at half the height of the drum at a radial position of 14 cm from the center of the drum. These lie in said plane directly opposite one another (angular distance 180°). Otherwise the procedure is identical to example 1. The count rates as a function of the rotational angle θ are summarized in table 5. The chi-squared fit of the normalized count rate distribution is shown in FIG. 5.

TABLE 5
Count rates for two 500 cm³ Pb cylinders (r = 3.26 cm/h = 15 cm) at a radial position of 14 cm from the center of the drum
and an angular distance of 180° between the cylinders.

| θ | 0 | 45 | 90 | 135 | 180 | 225 | 270 | 315 | ${\sum }_{\text{?}}^{\text{?}}$ |
|---|---|---|---|---|---|---|---|---|---|
| Z(Ε_{γ},θ) | 0.810 | 0.478 | 0.756 | 1.195 | 0.810 | 0.478 | 0.756 | 1.195 | 6.478 |
| c/s | | | | | | | | | |
| R(Ε_{γ},θ) | 4.727 10⁻⁴ | 2.420 10⁻⁴ | 3.154 10⁻⁴ | 6.212 10⁻⁴ | 4.727 10⁻⁴ | 2.420 10⁻⁴ | 3.154 10⁻⁴ | 6.212 10⁻⁴ | 3.306 10⁻ [symbol] |
| c/s/g | | | | | | | | | |

[symbol]

indicates data missing or illegible when filed

The diameter of the reference sphere is D=13.01 cm and is outside the interval [Dₘᵢₙ,Dₘₐₓ]. The total mass of the cylinder calculated via scaling the reference mass with count rates and self-absorption is 10.7±3.4 kg and conforms well to the “true” value 11.34 kg according to the simulation assumption.

### EXAMPLE 5

Determination of the total mass of two 5000 cm³ Pb cylinders having radii of 7.97 cm and lengths of 25 cm. The cylinders lie in a plane at half the height of the drum at a radial position of 14 cm from the center of the drum. The cylinders lie in said plane directly opposite one another (angular distance 180°). Otherwise the procedure is identical to example 1. The count rates as a function of the rotational angle θ are summarized in table 6. The chi-squared fit of the normalized count rate distribution is shown in FIG. 6.

TABLE 6
Count rates for two 5000 cm³ Pb cylinders (r = 7.98 cm/h = 25 cm) at a radial position of 14 cm from the center of the drum
and an angular distance of 180° between the cylinders.

| θ | 0 | 45 | 90 | 135 | 180 | 225 | 270 | 315 | ${\sum }_{\text{?}}^{\text{?}}$ |
|---|---|---|---|---|---|---|---|---|---|
| Z(Ε_{γ},θ) | 4.846 | 2.934 | 4.832 | 7.272 | 4.846 | 2.934 | 4.832 | 7.271 | 39.766 |
| c/s | | | | | | | | | |
| R(Ε_{γ},θ) | 4.727 10⁻ [symbol] | 2.420 10⁻ [symbol] | 3.154 10⁻ [symbol] | 6.212 10⁻ [symbol] | 4.727 10⁻ [symbol] | 2.420 10⁻ [symbol] | 3.154 10⁻ [symbol] | 6.212 10⁻ [symbol] | 3.306 10⁻ [symbol] |
| c/s/g | | | | | | | | | |

[symbol]

indicates data missing or illegible when filed

The diameter of the reference sphere is D=32.20 cm and is outside the limit range [Dₘᵢₙ,Dₘₐₓ]. The total mass of the cylinder calculated via scaling the reference mass with count rates and self-absorption is 103±34 kg and conforms well to the “true” value 113.4 kg according to the simulation assumption.

### EXAMPLE 6

Determination of the total mass of a 1000 cm³ Pb cylinder having a radius of 2 cm and a length of 80 cm and a 1000 cm³ Pb cylinder having a radius of 14 cm and a length of 1.62 cm. The cylinders lie in a plane at half the height of the drum at a radial position of 14 cm from the center of the drum. The angular distance between the two cylinders is 90°. Otherwise the procedure is identical to example 1. The count rates as a function of the rotational angle θ are summarized in table 7. The chi-squared fit of the normalized count rate distribution with consideration for 1-point activity (1P) and 2-point activities (2P) is shown in FIG. 7.

1-point activity means that only one of the two sources present in the sample is taken into account for the simulation of the emitted gamma radiation, 2-point activity means that both sources are taken into account.

TABLE 7
Count rates for two 1000 cm³ Pb cylinders (r1 = 2 cm/h1 = 80 cm; r2 = 14 cm/h2 =1.62 cm) at a radial position of 14 cm from
the center of the drum and an angular distance of 90° between the cylinders.

| θ | 0 | 45 | 90 | 135 | 180 | 225 | 270 | 315 | ${\sum }_{\text{?}}^{\text{?}}$ |
|---|---|---|---|---|---|---|---|---|---|
| Z(Ε_{γ},θ) | 2.233 | 0.926 | 0.342 | 0.294 | 1.053 | 1.734 | 2.536 | 3.347 | 12.465 |
| c/s | | | | | | | | | |
| 1-point | 4.727 10⁻⁴ | 1.783 10⁻⁴ | 4.920 10⁻³ | 1.886 10⁻³ | 2.078 10⁻³ | 6.369 10⁻³ | 2.662 10⁻⁴ | 6.023 10⁻⁴ | 1.672 10⁻³ |
| activity | | | | | | | | | |
| R(Ε_{γ},θ) | | | | | | | | | |
| c/s/g | | | | | | | | | |
| 2-point | 5.219 10⁻⁴ | 1.972 10⁻⁴ | 6.998 10⁻³ | 8.255 10⁻³ | 2.870 10⁻³ | 6.660 10⁻³ | 7.389 10⁻⁴ | 7.806 10⁻⁴ | 3.344 10⁻³ |
| activities | | | | | | | | | |
| R(Ε_{γ},θ) | | | | | | | | | |
| c/s/g | | | | | | | | | |

The diameter of the reference sphere obtained via analysis of the normalized count rate distribution with 1-point activity is D=25.31 cm and is outside the interval [Dₘᵢₙ, Dₘₐₓ]. The total mass of the cylinder calculated by scaling the reference mass with count rates and self-absorption is 28.5±13.1 kg and is 25% higher than the expected value, 22.7 kg. This shows that the approximation of the sample is too inaccurate due to a single inclusion, which emits gamma radiation, for the two-part sample present here, and fails.

The diameter of the reference sphere obtained via analysis of the normalized count rate distribution with 2-point activities is D=17.89 cm and is within the interval [Dₘᵢₙ, Dₘₐₓ]. The total mass of the cylinder is twice the reference mass: 22.7±6.7 kg. Making the model precise for the sample therefore pays off in the form of a more accurate quantification of the sought element.

A new calibration set was created for example 7 since the radial position of the sought element in the sample was changed compared to the previous examples. In table 8, as in table 1, the angle-dependent count rates at 1064 keV (nuclide Pb-207m) for 1000 cm³ (p=11.34 g/cm³; m=11.34 kg) Pb cylinders having different radii and lengths (r, h) in a concrete matrix at a radial position of 8 cm from the center of the drum are plotted as a function of the rotational angle θ. The cylinders lie in a plane at half the height of the drum. The maximum length of the cylinder is fixed at 80 cm for a drum having a height of 86 cm. The maximum diameter of the cylinder is 28 cm and is equal to the radius of the drum. The density of concrete is 1.5 g/cm³.

TABLE 8

| | Z(Ε_{γ},θ) c/s | | | | | | | |
|---|---|---|---|---|---|---|---|---|
| θ | r = 2/h = 80 | r = 2.30/h = 60 | r = 2.82/h = 40 | r = 4/h = 20 | r = 5.64/h = 10 | r = 8.92/h = 4 | r = 14/h = 1.62 | R(Ε_{γ},θ) c/s/g |
| 0 | 1.033 | 0.982 | 0.882 | 0.711 | 0.581 | 0.478 | 0.472 | 2.172 10⁻⁴ |
| 45 | 0.605 | 0.571 | 0.516 | 0.417 | 0.341 | 0.283 | 0.284 | 1.336 10⁻⁴ |
| 90 | 0.304 | 0.289 | 0.260 | 0.210 | 0.172 | 0.144 | 0.150 | 6.308 10⁻ [symbol] |
| 135 | 0.173 | 0.164 | 0.148 | 0.120 | 0.099 | 0.082 | 0.085 | 3.762 10⁻ [symbol] |
| 180 | 0.173 | 0.165 | 0.148 | 0.120 | 0.098 | 0.082 | 0.083 | 4.005 10⁻ [symbol] |
| 225 | 0.343 | 0.327 | 0.294 | 0.240 | 0.195 | 0.164 | 0.169 | 7.476 10⁻ [symbol] |
| 270 | 0.799 | 0.758 | 0.683 | 0.552 | 0.452 | 0.380 | 0.396 | 1.655 10⁻⁴ |
| 315 | 1.20 | 1.136 | 1.028 | 0.829 | 0.678 | 0.563 | 0.565 | 2.655 10⁻⁴ |
| ${\sum }_{\text{?}}^{\text{?}}$ | 4.630 | 4.392 | 3.959 | 3.198 | 2.616 | 2.176 | 2.204 | 9.983 10⁻⁴ |
| D (cm) | 19.95 | 19.43 | 18.45 | 16.59 | 15.02 | 13.71 | 13.80 | |

[symbol]

indicates data missing or illegible when filed

D is the diameter of the sphere, the emission behavior of which is equivalent to that of the particular cylinder under consideration. The parameters for the self-absorption of 1064 keV in Pb are: a(E_{γ})=0.1397; b(E_{γ})=0.4098 und c(E_{γ})=0.0737.

The mean count rate is Z̅_̅{̅r̅e̅f̅}̅(̅E̅_̅{̅λ̅}̅)̅=3.311±1.028 c/s. This results in a mean diameter D̅_̅{̅r̅e̅f̅}̅ of the reference sphere of 16.87 cm. The diameters are between Dₘᵢₙ=13.80 cm and Dₘₐₓ=19.95 cm.

### EXAMPLE 7

Determination of the total mass of a 1000 cm³ Pb cylinder having a radius of 2 cm and a length of 80 cm at a radial position of 14 cm from the center of the drum and a 5000 cm³ Pb cylinder having a radius of 7.98 cm and a length of 25 cm in the center of the drum. The cylinders lie in a plane at half the height of the drum at a radial position of 14 cm from the center of the drum. Otherwise the procedure is identical to example 1. The count rates as a function of the rotational angle θ are summarized in table 9. The chi-squared fit of the normalized count rate distribution with consideration for 1-point activity is shown in FIG. 8. The best chi-squared value is obtained for a mean radial position of 8 cm.

TABLE 9
Count rates for a 1000 cm³ Pb cylinder (r = 2 cm/h = 80 cm) at a radial position of 14 cm from the center of the drum
and a 5000 cm³ Pb cylinder (r = 7.98 cm/h = 25 cm) in the center of the drum.

| θ | 0 | 45 | 90 | 135 | 180 | 225 | 270 | 315 | ${\sum }_{\text{?}}^{\text{?}}$ |
|---|---|---|---|---|---|---|---|---|---|
| Z(Ε_{γ},θ) | 2.740 | 1.605 | 1.213 | 1.077 | 1.069 | 1.348 | 2.30 | 3.943 | 15.295 |
| c/s | | | | | | | | | |
| R(Ε_{γ},θ) | 2.172 10⁻⁴ | 1.336 10⁻⁴ | 6.308 10⁻⁴ | 3.762 10⁻⁴ | 4.005 10⁻⁴ | 7.476 10⁻⁴ | 1.655 10⁻⁴ | 2.655 10⁻⁴ | 9.983 10⁻⁴ |
| c/s/g | | | | | | | | | |

The diameter of the reference sphere obtained via analysis of the normalized count rate distribution with 1-point activity is D=36.37 cm and is outside the interval [Dₘᵢₙ, Dₘₐₓ]. The total mass of the cylinder calculated according to equation (17) is 77±28 kg and is 13% higher than the expected value, 68 kg. The sample assumed in example 7 can therefore be approximated relatively well as a shielded single gamma radiation source.

The reason therefor is that a large portion of the sought element, which is excited to gamma radiation by the neutron bombardment, is located in the center of the drum. There, said portion of the sought element does not affect the angle-dependence of the count rate when the drum is rotated.

1. A method for the non-destructive elemental analysis of large-volume samples, wherein:
the sample is irradiated with fast neutrons in a pulsed manner,
the gamma radiation emitted by the sample is measured, and
the quantity of an element contained in the sample is evaluated after the background signal is subtracted from the area of the photopeak caused by the element in a plot of count rate versus energy,
wherein
the gamma radiation emitted by a subregion of the sample, wherein a metallic enclosure of the sample is selected as the subregion, the composition of which is known, is evaluated in order to determine the neutron flux at the location of the sample wherein the sample is rotated about an axis and the gamma radiation is measured as a function of the rotational angle.

2.-3. (canceled)

4. The method according to claim 1, wherein the radial distribution of an element in the sample relative to the rotational axis is evaluated on the basis of the dependence of the gamma radiation on the rotational angle.

5. The method according to claim 1, wherein the sample is approximated for the determination of the photopeak efficiency of the element as a shielded point source comprising the element.

6. The method according to claim 1, wherein a previously determined radial distribution of the element in the sample relative to the rotational axis is used for the approximation of the sample.

7. The method according to claim 1, wherein the area of the photopeak is calculated on the basis of an assumption of a gamma-shielding structure contained in the sample, and the comparison of said area with the area obtained from measurement results is evaluated as a measure of the validity of the assumption.

8. The method according to claim 7, wherein the assumption is evaluated using a chi-squared test of the deviation between the area of the photopeak that was calculated and the area of the photopeak obtained from measurement results.

9. The method according to claim 1, wherein the area of the photopeak is calculated on the basis of a parametrized approach for the effect of a gamma-shielding structure contained in the sample, and the deviation of said area from the area obtained from measurement results is minimized by varying the parameters, in particular according to the chi-squared method.

10. The method according to claim 9, wherein findings from a previously conducted qualitative elemental analysis of the sample are used to limit or define the parameters of the gamma-shielding structure.

11. The method according to claim 7, wherein the expected ratio of the photopeak areas generated by various gamma lines of the element being sought in the sample is taken into account in the assumption or in the parametrized approach.

12. The method according to claim 1, wherein the sample is rotated and the dependence of the gamma radiation emitted by the sample on the rotational angle is calculated on the basis of an assumption of the position of a locally concentrated element in the sample, and in that the comparison of this angle-dependence with the angle-dependence obtained from measurement results is evaluated as a measure of the validity of the assumption.

13. The method according to claim 12, wherein the validity of the assumption is evaluated using a chi-squared test of the deviation between the angle-dependence that was calculated and the angle-dependence obtained from measurement results.

14. The method according to claim 1, wherein the dependence of the gamma radiation emitted by the sample on the rotational angle is calculated on the basis of a parametrized approach liar the position of the locally concentrated element in the sample, and the deviation from the angle-dependence obtained from measurement results is minimized by varying the parameters, in particular using the chi-squared method.

15. The method according to claim 12, wherein
the diameter of a sphere made of the element is calculated, wherein said sphere, if placed at the location of the local concentration of the element in the sample, would exhibit the measured dependence of emitted gamma radiation on the rotational angle, and
the total mass in of the element concentrated locally in the sample is evaluated on the basis of the comparison of said diameter with the diameter of a reference sphere made of the element, the mass of which is known.

16. The method according to claim 15, wherein the sphere that is selected as the reference sphere is such that said sphere, if placed at the location of the local concentration of the element in the sample, would exhibit the same dependence of measured gamma radiation on the rotational angle as would a cylinder that is made of the element, has a specified geometry, and is located at that very point.

17. The method according to claim 1, wherein the gamma radiation is measured in the time interval after a neutron pulse in which at least 50% of the neutrons of the pulse are moderated to energies between 100 eV and 1 KeV.

18. The method according to claim 1, wherein the gamma radiation is measured in the time interval after a neutron pulse in which at least 50% of the neutrons of the pulse are moderated to energies below 1 eV.

19. The method according to claim 1, wherein the sample is irradiated with neutrons haying an energy above 10 MeV.

20. The method according to claim 1, wherein at least a portion of the neutrons that pass through the sample is reflected back into the sample.

21. A device for carrying out the method according to claim 1, comprising a sample chamber for accommodating the sample to be examined, a pulsed neutron source for irradiating the sample, and a detector for the gamma radiation emitted by the sample, wherein the sample chamber is surrounded by a neutron-reflecting material, which is capable of reflecting neutrons that are not absorbed by the sample back into the sample chamber and in that the device comprises a rotary table for the sample.

22. The device according to claim 21, wherein the neutron-reflecting material is graphite.

23. The device according to claim 21, wherein an arrangement of the detector relative to the sample chamber is such that the sample fills a solid angle of at most 0.6 steradian, as viewed from the detector.

24. (canceled)

25. The device according to claim 21, wherein the detector comprises a primary detector for the gamma radiation emitted by the sample, a secondary detector, which at least partially surrounds the primary detector, and means for an anticoincidence circuit of primary detector and secondary detector.

26. The device according to claim 21, wherein the detector comprises a neutron shielding made of ⁶Li.
